(19) United States
(12) Patent Application Publication
(10) Pub. No.: US 2008/0189128 A1
(43) Pub. Date: Aug. 7, 2008

(54) Integrated system and method for supplying identical parts with multiple certifications

(75) Inventor: Pete Curti, Chino Hills, CA (US)

Correspondence Address: KOPPEL, PATRICK & HEYBL, 555 ST. CHARLES DRIVE, SUITE 107, THOUSAND OAKS, CA, 91360, US

(73) Assignee: KIRKHILL AIRCRAFT PARTS COMPANY, INC.

(21) Appl. No.: 12/069,243

(22) Filed: Feb. 7, 2008

Related U.S. Application Data
(60) Provisional application No. 60/900,294, filed on Feb. 7, 2007.

(51) Int. Cl. G06Q 10/00; G06Q 30/00

(52) U.S. Cl. 705/1

(57) ABSTRACT

Methods and computer based systems for supplying the same aircraft part under different part certifications comprises a communication link for accepting part orders from an aircraft manufacturer or a third party. A first computer subsystem is included for determining whether the order came from an aircraft manufacturer or a third party. A second computer subsystem is included for generating certification paperwork and statements for the aircraft manufacturer certification corresponding to a part ordered by said aircraft manufacturer. A third computer subsystem generates certification paperwork and statements for a vendor certification corresponding to a part ordered by said third party.

The present invention claims the benefit of U.S. Provisional Patent Application Ser. No. 60/900,294 to Curti, filed on Feb. 7, 2007.

### BACKGROUND OF THE INVENTION

1. Field of the Invention

This invention relates to systems for supplying parts to end users, and in particular a system for supplying aircraft parts to end users under different ones of multiple certifications.

2. Description of the Related Art

Replacement parts for different types of vehicles can be sold or supplied to end users under different certification programs. For aircraft parts there are several Federal Aviation Administration (FAA) approval or certifications, such as a Type Certificate (TC) that is required for a particular aircraft design. For example, a Boeing 757-200 would have a TC issued by the FAA that indicates the aircraft, as designed, is deemed airworthy and meets all FAA design and flight safety requirements necessary (on paper) prior to first test flight.

Another approval or certification type is the Production Certificate (PC) that is granted after physical & fundamental testing requirements are met (i.e. operational flight testing). This allows the aircraft manufacturer to move forward with production & sales of aircraft, including spare components. In the case, for example, of the Boeing 757-200, Boeing will be the TC and the PC holder. This is known as being a Production Approval Holder (PAH) and means having an FAA approved fabrication inspection system to ensure the “product” goes through a “quality window” determining it meets its type design and is airworthy as originally designed to the type certificate.

Aircraft parts are typically produced by the aircraft manufacturer, or by outside vendors under the aircraft manufacturer's direction. In both cases the parts must be manufactured to the manufacturer's engineering documents, specifications, etc, and approved by the manufacturer's quality system. The parts are then given an FAA designation number, such as PC700 for Boeing, which means that they are approved Boeing parts.

There are other types of Production Approvals for aircraft parts such as PMA, which is for modification and replacement parts being sold for installation on type certificated products not produced by the Production Certificate holder (in this example Boeing). This type of approval is granted by the FAA to non-Production Certificate holders and allows these entities to make and sell parts that are deemed airworthy by the FAA. The FAA takes full oversight for all Quality requirements meeting the type design.

There are two main ways to get PMA from the FAA on a particular part. The first is to license the intellectual property (drawing, specs, etc) from the PC holder, and then get the PC holder to file a letter with the FAA indicating that they are allowing you to make their parts. Generally speaking, the company selling the PMA part in this case will pay a royalty to the PC holder as the licensor.

The second way to get PMA is to show that your part is exactly the same in form, fit, function, etc to the PC holder's part and is called identicality by test and computation. Also, the PC holder is not associated with any part of this process nor do they endorse this process. In this scenario the PMA holder is not tied directly to the configuration control of the aircraft. The PC holder's typically do not encourage PMA certification, as it results price competition for the parts and does not allow for the payment of royalties.

The PMA part has its own “quality window” outside of the Production Approval Holder's, and maintains an FAA approved fabrication inspection system. The PMA part requires special marking per FAR (Federal Aviation Requirement) 45.15 which includes model eligibility (i.e. 757-200). The PC part does not have said requirements. Although from a regulatory standpoint both are “FAA approved parts” there is a hierarchy based on the “quality window” meaning: the PMA part is not acceptable to the PC quality system since it was manufactured outside the PC quality system.

Some outside vendors enter into arrangements aircraft manufacturers, whereby the vendor can source or manufacturer in-house, inspect, stock, and ship parts to its end customers on behalf of this aircraft manufacturer. Under this arrangement, the outside vendor can be paid the cost of the part plus a “management fee”, which is essentially the vendor's fee for performing this service. These arrangements can be directed to thousands of different parts supporting different aircraft such as legacy aircraft.

In one part ordering system, when an airline customer orders one of these parts from the aircraft manufacturer (such as Boeing), the aircraft manufacturer has a system that takes the order. The manufacturer's ordering system then communicates the order information to a separate system that handles procurement. The procurement system generates a purchase order which is sent to an outside vendor, and the outside vendor receives the order and ships the part directly to the end customer. The outside vendor then bills the aircraft manufacturer for the part, the aircraft manufacturer bills the customer for the part, etc.

### SUMMARY OF THE INVENTION

One embodiment of a computer based system for supplying the same aircraft part under different part certifications comprises a communication link for accepting part orders from an aircraft manufacturer or a third party. A first computer subsystem is included for determining whether the order came from an aircraft manufacturer or a third party. A second computer subsystem is included for generating certification paperwork and statements for the aircraft manufacturer certification corresponding to a part ordered by said aircraft manufacturer. A third computer subsystem generates certification paperwork and statements for a vendor certification corresponding to a part ordered by said third party.

Another embodiment of a computer based system according to the present invention for supplying the same aircraft part to different categories of customers using a different part certification for each of said categories of customers comprises a communication link for accepting aircraft part orders from each of said categories of customers. A first computer subsystem is included for differentiating whether said order came from one of said categories of customers, and determining the certification to be used for said part order based on the one of said categories of customers. A second computer subsystem is included for generating certification paperwork and statements for a first part certification corresponding to one of the categories of customers. A third computer subsystem is also included for generating certification paperwork and statements for a second part certification corresponding to another one of the categories of customers.

One method for supplying the same aircraft part under different part certifications according to the present invention comprises accepting a part order from an aircraft manufacturer or a third party and determining whether the order originated from an aircraft manufacturer or a third party. Certification paperwork and statements are generated for the aircraft manufacturer certification corresponding to a part ordered by the aircraft manufacturer. Certification paperwork and statements can also be generated for a vendor certification corresponding to a part ordered by the third party. Billing documentation is then generated based on where the part order originated from and the corresponding one of the aircraft manufacture and vendor certification.

These and other features and advantages of the invention will be apparent to those skilled in the art from the following detailed description of preferred embodiments, taken together with the accompanying drawing, in which:

### BRIEF DESCRIPTION OF THE DRAWINGS

FIG. 1 is a flow diagram for one embodiment of an integrated system and method according to the present invention for supplying parts with multiple certifications.

### DETAILED DESCRIPTION OF THE INVENTION

The present invention provides an integrated and seamless system and method whereby the same parts can be supplied by an outside vendor to parts customers, such as aircraft manufacturer customers, under certification of the aircraft manufacturer as described above, with the same part also being supplied under a separate third party FAA approval or certificate. The parts can be manufactured to meet both the outside vendor and aircraft manufacturer certification requirements. These different certification requirements can result from completely different quality requirements, with the part typically meeting the highest quality requirements of the two.

The systems according to the present invention are typically embodied in conventional computer network systems that can have servers and terminals, with software and databases arranged to handle the different procurement processes using the different certifications.

The present invention is described herein with reference to certain embodiments but it is understood that the invention can be embodied in many different forms and should not be construed as limited to the embodiments set forth herein. In particular, the present invention is described below in regards to certain systems and methods related to aircraft manufactures, aircraft parts and their certification.

It is also understood that when an element such as a component or feature is referred to as being “coupled to” or “in communication with” another component or feature, or the like, it can be directly coupled to or in communication with the component or feature or intervening elements may also be present. Although the terms first, second, etc. may be used herein to describe various elements or components, these elements or components should not be limited by these terms. These terms are only used to distinguish one element or component from another and thus, a first element or component discussed below could be termed a second element or component without departing from the teachings of the present invention.

In some embodiments of systems according to the present invention, an outside vendor can market and sell a part as both a aircraft manufacturers certified part (e.g. PC700) and under the vendor's own certification (such as PMA). The part can be approved and provided through the quality system of the aircraft manufacturer, and through the quality system provided by the vendor through FAA certification. Both are independent of each other.

The system allows procurement of all aircraft manufacturer proprietary products under the manufacturer's drawings and specific quality requirements as if the products were to be supplied only to the aircraft manufacturer (e.g. PC700 Quality Requirements for Boeing). If the manufacturer receives an order from a customer, the outside vendor can ship the part directly to the customer with aircraft manufacturer's certification statement (PC700—saying that outside vendor is acting as the PC holder). This is known in the aircraft parts industry as Direct Ship Authority, which is authorized by the specific PC holder, e.g. Boeing.

The outside vendor can be authorized to ship on behalf to the customer PC holder, but can also be authorized through FAA approved Designated Manufacturing Inspection Representative (DMIR) to sign tags for airworthiness and export approval, such as FAA 8130-3 tags. This is the highest status level an outside vendor can have in the aircraft parts industry without obtaining their own Production Certificate approval.

The same part can be sold by the outside vendor directly to the aircraft aftermarket by virtue of licensing (PMA) with the aircraft manufacturer or by a PMA from the FAA. Under this feature of the system according to the present invention, there is substantially no difference between the quality requirements for an outside vendor's own FAA approval and the quality requirement of the aircraft manufacturer. The same part can be sold and shipped to an end customer using a PMA certification statement. When doing so, the certification statement can be automated based on logic of the “product category” (i.e. what type of product is being sold, the proprietary owner of the product, and procurement, inspection, & control configuration of the product) and who the product is being sold to. The customer base can categorized by customer type based on what type of quality requirements they expect. According to the present invention, one part can be purchased, manufactured and/or stocked, but can be with two different FAA approvals at the same time to a wide variety of customers. This provides a unique system in the industry because of automated and tied logic between customer type and product category.

It is understood that the present invention can be used with many different aircraft manufacturers or other vehicle part manufacturers. The uniqueness lies within the process itself providing the ability to stock, control, inspect, and package to one quality system, yet allowing certification to an additional quality system by virtue of other stringent controls and automation. This system allows for improved efficiency by alleviating dual manufacturing and procurement of the particular product and dual stocking and processing of the product. These processes according to the present invention control cost and G&A overhead, and allow aggregated demand for the product sold through at least two channels. The outside vendor is typically indifferent to which channel the customer chooses (through the Production Certificate Holder or direct buy as a PMA product) because the product is picked from the same single bin in the warehouse.

In one embodiment, the outside vendor controls the quality and configuration to the type design specifications of a particular part. The outside vendor provides the part meeting the higher level quality requirements, and it is stocked as such to ship. If the order is through the outside vendor certification, the system according to the present invention facilitates the printing of correct documents and marking requirements. Additional system logic can be provided that prints specific FAA required certification language on shipping documents and part marking based on the attributes of the part and also the customer it is being sold to.

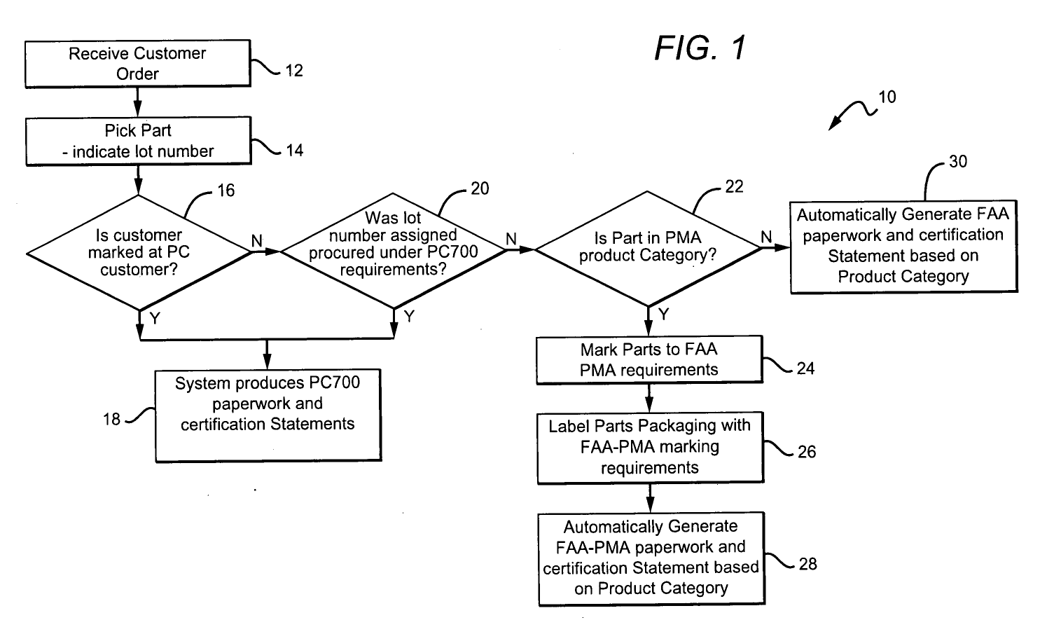

FIG. 1 shows on embodiment of flow diagram for one embodiment of a procurement system 10 according to the present invention. The system 10 can be implemented in many different computer network architectures. The details of such systems are generally known in the art and only briefly discussed herein. In one embodiment, the system 10 can be implemented on the server that is connected to personal computers (PCs) running dumb terminal emulators, and/or handheld computers. The PCs and handhelds can communicate to the server through wired or wireless networks. The software one the server can be implemented in different programming languages, such as Progress 4GL that can be integrated with a different known commercial package called SX. Enterprise. The data can be stored on the server in different databases, such as a commercially available Progress database this is a database engine similar to other commercially available databases provided by Oracle or Sql Server. In one embodiment the system 10 is run automatically and seamlessly, such as providing for electronic signatures, electronic record keeping, and automated parts handling.

The diagram 10 is described with reference to certain steps or stages and it is understood that each of the steps can be a computer subsystem within the overall computer system. In 12, the system accepts a part order, either from the aircraft manufacturer or a third party customer. The order can be received electronically, such as through an Electronic Data Interchange (EDI), or through other means such as mail, phone, fax, email, at a web-site over the internet. As described above, the different parts are binned together regardless of whether the part is being supplied as an aircraft manufacturer part under one certification, or as an outside vendor part under another certification. In 14 the part is picked from a bin, either manually or by machine, and the lot number can be read from the part.

In 16 it is determined whether the customer is an aircraft manufacturer customer (i.e. PC customer) and depending on whether it is, different paperwork and labeling can be provided. If it is a PC customer, in 18 the system 10 produces aircraft manufacturer paperwork and certification statements to go with the part, and in the preferred embodiment this is done automatically. The part can then be shipped and the appropriate billing paperwork or communications can be generated.

If in 16 it is determined that it is not an aircraft manufacturer customer, then in 20 a determination is made as to whether the particular part being supplied is from a lot manufactured under requirements of the aircraft manufacturer, or is a lot number from parts acquired from the aircraft manufacturer. If the answer is yes, then the system 10 returns to 18 where the system produces aircraft manufacturer paperwork and certification statements, preferably automatically.

In some embodiments, when these orders are received directly by the aircraft manufacturer or electronically sent by EDI (i.e. Storefront), there is a mapping process that allows the aircraft manufacturer to indicate if they require specific FAA 8130-3 tags with their shipments. If it is indicated “yes”, the order is routed to our “FAA Inspector station” in final shipping to allow for attachment of this documentation. This is typically done through a secured system within the mainframe computer system. The FAA tags are preferably provided by a person trained, registered, and approved directly by the FAA to provide this service. When an order is Direct Shipped under a Product Certificate Holder (PAH) from the aircraft manufacturer, the aircraft manufacturer can grant the outside vendor the ability to sign these tags on their behalf with FAA concurrence as well. The part can then be shipped and the appropriate billing paperwork or communications can be generated.

If the answer from 20 is no, then in 22 a determination is made whether the part was manufactured by the outside vendor under its own certification, e.g. PMA product category. If yes, then in 24 the part is marked to meet requirements of the outside vendor certification, such as FAA-PMA requirement. In 26, the packaging for the part is likewise is likewise labeled with the outside vendor marking requirements, such as FAA-PMA marking requirements. In 28, the outside vendor certification paperwork and certification statement can be generated based on the product category, such as FAA-PMA certification paperwork. When these orders are booked, Customer Codes can set up internally to indicate what type of customer they are. If they are an Airline, Maintenance Repair & Overhaul facility, or Broker—they can also ask for an FAA 8130-3 tag. At the customer level, a flag can be set up indicating for those items or customers a FAA tag should be supplied, This can be an automatic process at the final shipping station. In one embodiment this is done automatically, the part is shipped, and the appropriate billing documentation is generated.

In 30 the system 10 can automatically generate certification paperwork, such as FAA certification statement based on product category. This is where paperwork is provided for parts provided under “Industry/Government” Standards, and raw materials that do not require FAA approval or tags.

While several illustrative embodiments of the invention have been shown and described, numerous variations and alternate embodiments will occur to those skilled in the art. Such variations and alternate embodiments are contemplated, and can be made without departing from the spirit and scope of the invention.

I claim:

1. A computer based system for supplying the same aircraft part under different part certifications, comprising:
a communication link for accepting part orders from an aircraft manufacturer or a third party;
a first computer subsystem for determining whether the order came from an aircraft manufacturer or a third party;
a second computer subsystem for generating certification paperwork and statements for the aircraft manufacturer certification corresponding to a part ordered by said aircraft manufacturer; and
a third computer subsystem for generating certification paperwork and statements for a vendor certification corresponding to a part ordered by said third party.

2. The system of claim 1, wherein said communication link comprises an electronic data link.

3. The system of claim 1, wherein said communication link comprises one from the group comprising mail, phone, fax, email and the Internet.

4. The system of claim 1, wherein said third computer subsystem further comprises a mechanism for marking parts pursuant to said vendor certification.

5. The system of claim 1, wherein said third computer subsystem further comprises a mechanism for labeling parts packaging pursuant to said vendor certification.

6. The system of claim 1, wherein said first aircraft manufacturer certification and said vendor certification comprise Federal Aviation Association (FAA) certifications.

7. A computer based system for supplying the same aircraft part to different categories of customers using a different part certification for each of said categories of customers, comprising:
a communication link for accepting aircraft part orders from each of said categories of customers;
a first computer subsystem for differentiating whether said order came from one of said categories of customers, and determining the certification to be used for said part order based on the one of said categories of customers;
a second computer subsystem for generating certification paperwork and statements for a first part certification corresponding to one of said categories of customers; and
a third computer subsystem for generating certification paperwork and statements for a second part certification corresponding to another one of said categories of customers.

8. The system of claim 7, wherein said communication link comprises one from the group comprising an electronic data link, mail, phone, fax, email and the Internet.

9. The system of claim 7, wherein said third computer subsystem further comprises a mechanism for marking parts pursuant to said vendor certification.

10. The system of claim 7, wherein said third computer subsystem further comprises a mechanism for labeling parts packaging pursuant to said vendor certification.

11. The system of claim 7, wherein said first and second part certifications comprise an aircraft manufacturer certification and a vendor certification, respectively.

12. The system of claim 7, wherein said first and second part certifications comprise Federal Aviation Association (FAA) certifications.

13. The system of claim 7, further comprising a fourth computer subsystem generating billing documentation corresponding to said part and its respective one of said first and second certifications.

14. A method for supplying the same aircraft part under different part certifications, comprising:
accepting a part order from an aircraft manufacturer or a third party;
determining whether said order originated from an aircraft manufacturer or a third party;
generating certification paperwork and statements for the aircraft manufacturer certification corresponding to a part ordered by said aircraft manufacturer;
generating certification paperwork and statements for a vendor certification corresponding to a part ordered by said third party; and
generating billing documentation based on where said part order originated from and the corresponding one of said aircraft manufacture and vendor certification.

15. The method of claim 14, further comprising a mechanism for marking parts pursuant to said aircraft manufacturer or vendor certification.

16. The system of claim 14, further comprising labeling parts packaging pursuant to said aircraft manufacturer or vendor certification.

17. The system of claim 1, further comprising generating documentation for shipping of said part to said aircraft manufacturer or third party.
